(19) United States
(12) Patent Application Publication
(10) Pub. No.: US 2019/0283880 A1
(43) Pub. Date: Sep. 19, 2019

(54) AIRCRAFT OVERHEAD BIN MONITORING SYSTEM AND METHOD OF USE

(71) Applicant: Ayushi Agarwala, Plano, TX (US)

(72) Inventor: Ayushi Agarwala, Plano, TX (US)

(21) Appl. No.: 16/358,307

(22) Filed: Mar. 19, 2019

Related U.S. Application Data
(60) Provisional application No. 62/645,012, filed on Mar. 19, 2018.

(51) Int. Cl. B64D 11/00

(52) U.S. Cl. CPC B64D 11/0015; B64D 11/003

(57) ABSTRACT

An aircraft overhead bin monitoring system includes an overhead bin having an interior compartment; a first sensor having a unique identifier correlating to the overhead bin, attached to the overhead bin, and to detect capacity data as determined via sensing the presence of items within the interior compartment; a computing device in data communication with the first sensor; the computing device is to determine an estimation of open space within the interior compartment based on the capacity data; and the computing device is to provide a user with the estimate of open space.

### BACKGROUND

### 1. Field of the Invention

The present invention relates generally to aircraft cargo transport systems, and more specifically, to an aircraft overhead bin monitoring system for improved loading of passengers and cargo into the aircraft by providing data regarding cargo space of one or more overhead bins.

### 2. Description of Related Art

Aircraft cargo transport systems are well known in the art and are effective means to hold and transport cargo and luggage for passengers. For example, FIG. 1 depicts a conventional overhead bin 101 having a body 103 with a door 105 covering an interior compartment 107 for receiving luggage 109 therein. During use, passengers load a plane and place their items in the overhead bin for transport.

One of the problems commonly associated with system 101 is disorganization. For example, it is common for passengers to have trouble finding space in an overhead bin for their luggage, therefore, it takes passengers an inconvenient amount of time to load the plane with their cargo. In addition, aircraft personnel, such as flight attendants, frequently have to open and close the overhead bins to find empty space, thereby taking additional time.

Accordingly, although great strides have been made in the area of aircraft cargo transport systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is an oblique view of a common overhead bin of an aircraft cargo transport system;

FIG. 2 is a simplified schematic of an aircraft overhead bin monitoring system in accordance with a preferred embodiment of the present application;

FIG. 3 is a front view of one embodiment of an aircraft overhead bin in accordance with the present application;

FIG. 4 is a top view of a base of an aircraft overhead bin in accordance with an alternative embodiment of the present application;

FIG. 5 is a flowchart of the method of use of the system of FIG. 2;

FIG. 6 is a schematic of an alternative embodiment of an aircraft overhead bin monitoring system in accordance with the present application; and

FIG. 7 is a flowchart of the method of use of the system of FIG. 6.

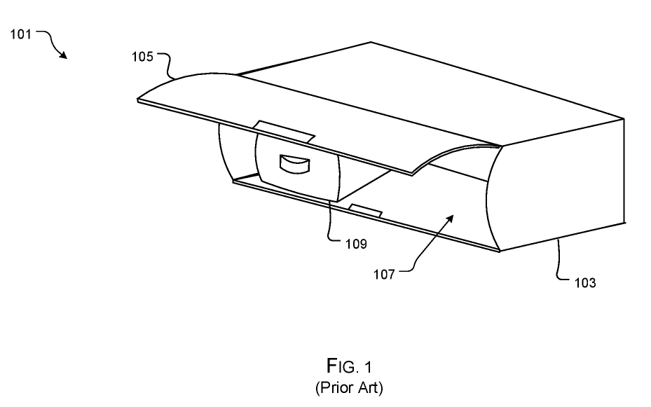

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional aircraft cargo transport systems. Specifically, the present invention provides a means to transmit capacity data to a user, such as a flight attendant or other aircraft personnel, regarding the availability of space in overhead bins. In addition, the present invention provides a means to indicate availability of space within the overhead bins to passengers, thereby improving the efficiency and flow of passenger loading. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

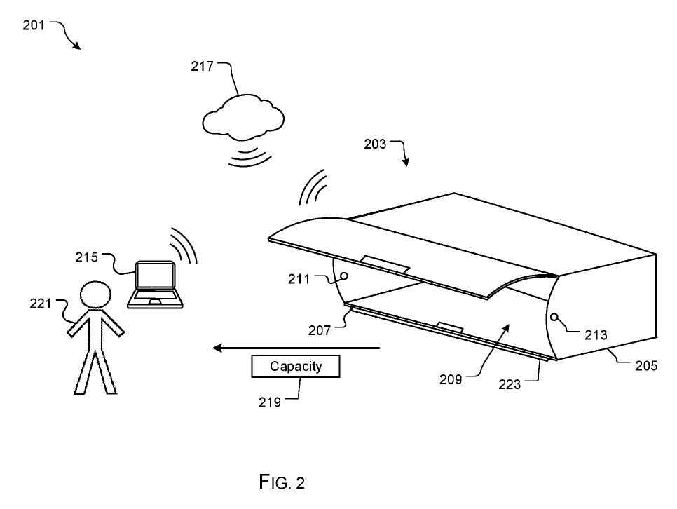

Referring now to the drawings wherein like reference characters identify corresponding or similar elements throughout the several views, FIG. 2 depicts a simplified schematic of a overhead bin monitoring system 201 in accordance with a preferred embodiment of the present application. It will be appreciated that system 201 overcomes one or more of the above-listed problems commonly associated with conventional cargo transport systems.

In the contemplated embodiment, system 201 includes an overhead bin 203 having a body 205 with a base 207 and an internal compartment 209 configured to receive luggage therein. It should be appreciated that although overhead bins typically come in conventional sizes and dimensions, the present invention can be adapted for use with any overhead bin of various sizes and styles, currently known or developed in the future.

System 201 further includes one or more sensors 211, 213 attached to bin 203 and configured to determine capacity data associated with the bin. It should be appreciated that the one or more sensors 211, 213 are programed with unique identifiers correlated to the bin, thereby ensuring that the data can be further be correlated to a specific bin to provide accurate information. It should be appreciated that the sensors can include laser sensors configured to detect objects, weight sensors, RFID sensors, or any additional type or style of sensors.

In the preferred embodiment, the sensors 211, 213 are in data communication with a computer 215 via a network 217, wherein the computing device is configured to receive the capacity data 219 to provide a user 221 (such as aircraft personnel) with notifications and information regarding the capacity of each of the overhead bins. It should be appreciated that the computer could be a tablet, phone, kiosk, or any computing device and could provide the user with information in the form of notifications, charts, graphs, plots, or any other means.

In some embodiments, system 201 further includes one or more indicators 223 configured to provide passengers and aircraft personnel with a visual representation of available space. The indicator 223 could be a light, wherein the light is programmed to change color based on whether or not the sensors and computer have determined available room in the bin.

It should be appreciated that one of the unique features believed characteristic of the present application is the incorporation of one or more sensors configured to provide information on the capacity of the overhead bins of an aircraft.

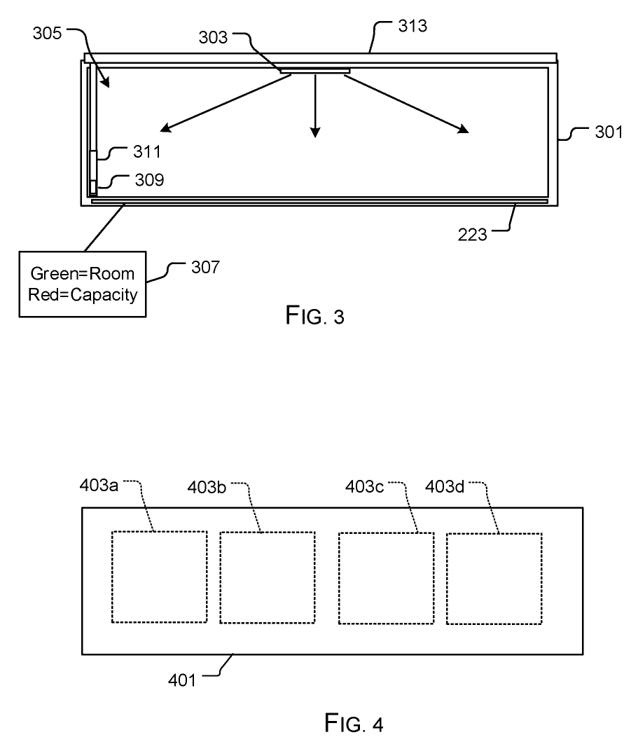

In FIG. 3, a front view depicts one embodiment of an overhead bin 301, wherein one or more sensors 303 are secured to a top of the bin 301 (or other reasonable location) and configured monitor the interior compartment 305 via lasers, radio waves, or the like, wherein the sensor determines the presence of one or more items to further determine the capacity of the bin. Bin 301 further includes indicator 223 configured to change colors 307 based on the availability of room in the bin. Indicator 223 could further include text indicating availability, be positioned at various locations on the bin, or any other modification providing the same functionality. Bin 301 could further include a control system 309 in communication with a lift 311, wherein the control system 309 is configured to receive commands from the computer or sensors in order to command the lift 311 to close the door 313 based on determination that the bin is at capacity. It should be appreciated that lift 311 is any electronic door control apparatus known in the art.

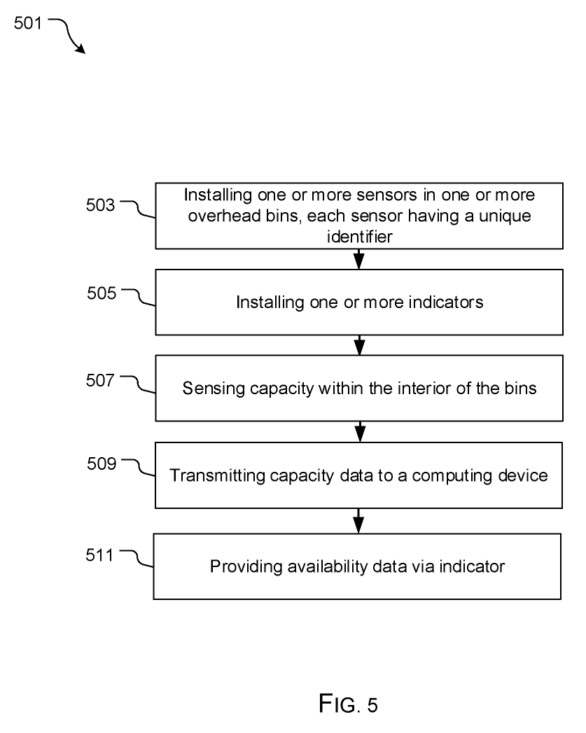

In FIG. 4, a top view of a base 401 of an overhead bin in accordance with an alternative embodiment of the present application is shown. In this embodiment, all of the features discussed above are considered interchangeable herewith. One or more weight sensors 403a-d are embedded in base 401 to detect the presence of luggage and provide data to the computer.

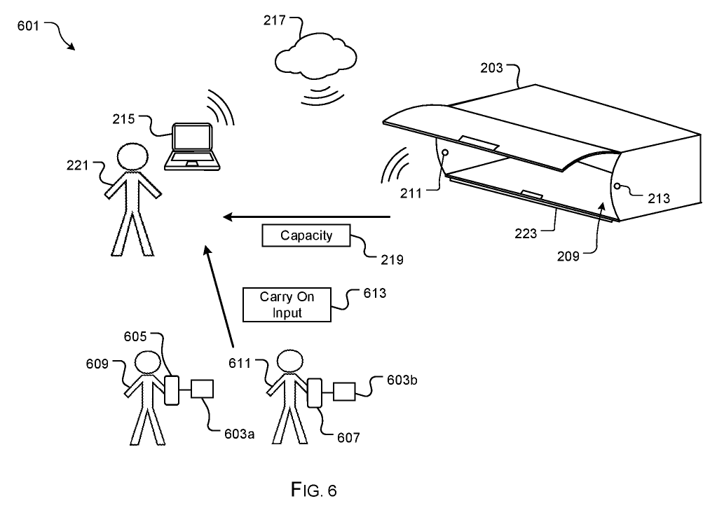

In FIG. 5, a flowchart 501 depicts a method of use of system 201. During use, the one or more sensors and indicators are installed into the one or more overhead bins, as shown with boxes 503, 505. The one or more sensors then detect items within the interior compartment, thereby providing capacity data to the computer, as shown with boxes 507, 509. The indicator then provides a visual representation of available capacity, as shown with box 511.

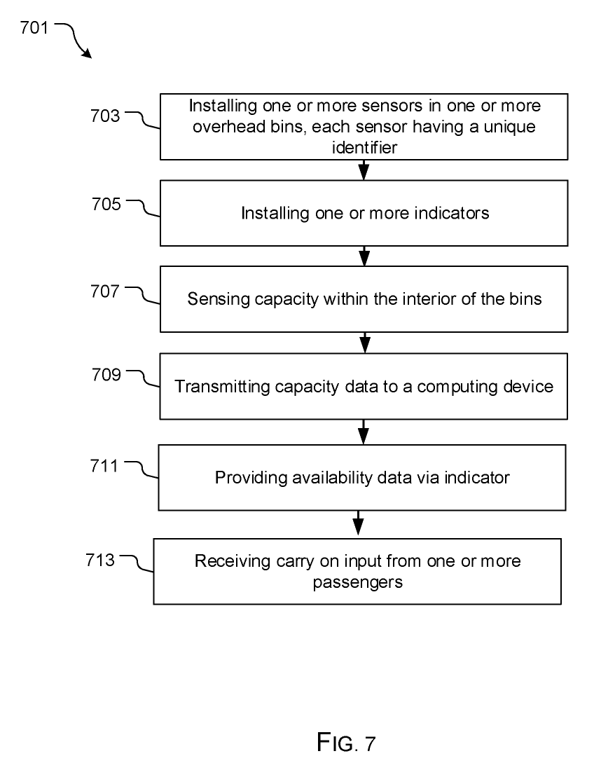

In FIG. 6, a simplified schematic of an alternative embodiment of an overhead bin monitoring system 601 is shown. In this embodiment, all of the features discussed herein are included. System 601 further includes a platform 603a-b accessible via secondary computing devices 605, 607, such as mobile phones, computers, tablets, kiosks or the like, wherein passengers 609, 611 can input carry on data 613, such as quantity, weight, and/or dimensions of luggage that the passenger is to carry on to the plane that will be stowed in the overhead bins. This data can be collected prior to flight, such as during online check in. This data could include whether they will have items for the overhead bins at all or just items that will fit underneath their seat. This data can further be used by the aircraft personnel to provide information for a smooth loading of all passengers and luggage. This data could further lead to improved tracking and management of luggage, plus bin reservations, bin availability prediction analysis etc. By way of example, as the passenger provides information, they could be provided with the ability to reserve a specific overhead bin near their seat, or in another preferred location, thereby making the traveling process flow more smoothly for the passenger.

In FIG. 7, a flowchart 701 depicts a method of use of system 601. During use, the one or more sensors and indicators are installed into the one or more overhead bins, as shown with boxes 703, 705. The one or more sensors then detect items within the interior compartment, thereby providing capacity data to the computer, as shown with boxes 707, 709. The indicator then provides a visual representation of available capacity, as shown with box 711. In this embodiment, carry on data is further received from one or more passengers to improve the efficiency of loading an aircraft, as shown with box 713.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. An aircraft overhead bin monitoring system, comprising:
an overhead bin having an interior compartment;
a first sensor having a unique identifier correlating to the overhead bin and attached to the overhead bin and configured to detect capacity data as determined via sensing the presence of items within the interior compartment;
a computing device in data communication with the first sensor;
wherein the computing device is configured to determine an estimation of open space within the interior compartment based on the capacity data; and
wherein the computing device is configured to provide a user with the estimate of open space.

2. The system of claim 1, wherein the first sensor is a weight detection sensor.

3. The system of claim 1, wherein the first sensor is a laser sensor.

4. The system of claim 1, further comprising:
a first indicator attached to the overhead bin and in communication with the computing device;
wherein the first indicator changes based on the estimation of open space.

5. The system of claim 4, wherein the first indicator is a color changing light.

6. The system of claim 1, further comprising:
a platform accessible via a second computing device and configured to perform the steps of:
receiving input from one or more passengers regarding the one or more passengers' carry on baggage; and
transmit the input to the computing device to provide the user with additional information.

7. An aircraft overhead bin monitoring system, comprising:
an overhead bin having an interior compartment;
a first sensor having a unique identifier correlating to the overhead bin and attached to the overhead bin and configured to detect capacity data as determined via sensing the presence of items within the interior compartment; and
a first indicator attached to the overhead bin and in communication with the first sensor;
wherein the first indicator changes based on the estimation of open space to indicate available open space or lack of available open space.

8. The aircraft of claim 7, wherein the indicator is a color changing light.

9. A method of monitoring an aircraft overhead bin, the method comprising:
providing the system of claim 1;
sensing via the first sensor capacity data of the overhead bin;
transmitting the capacity data to the computing device; and
providing the user with an estimation of open space in the overhead bin.

10. The method of claim 9, further comprising:
receiving input from one or more passengers regarding the one or more passenger's carry on baggage; and
transmitting the input to the computing device for additional information.

11. The method of claim 9, further comprising:
providing an indicator in communication with the computing device; and
activating the indicator to provide an alert regarding the capacity of the overhead bin.
